(19) United States
(12) Patent Application Publication
(10) Pub. No.: US 2012/0037780 A1
(43) Pub. Date: Feb. 16, 2012

(54) WHEEL CHAIR LIFTING/TILTING DEVICE

(76) Inventors: Rafael Colon O'Neill, Miami, FL (US); Umberto A. Cerdido Baculo, Miami, FL (US)

(21) Appl. No.: 12/857,257

(22) Filed: Aug. 16, 2010

(51) Int. Cl. F16M 11/10; F16M 11/24

(52) U.S. Cl. 248/371; 248/161

(57) ABSTRACT

The present invention provides a wheel chair lifting/tilting device comprising a horizontal support, at least one lifting support, wherein the at least one lifting support is connected to the horizontal support, and at least one rear wheel stop, wherein the at least one rear wheel stop is positioned relative to the horizontal support, whereby a wheel chair is immobilized. It also includes a tilting and lifting mechanism for positioning a wheel chair bound individual while remaining in the wheel chair.

### CROSS REFERENCE TO RELATED APPLICATIONS

This application is a continuation-in-part of co-pending U.S. application Ser. No. 12/658,040, filed Feb. 1, 2010. The aforementioned application is hereby incorporated by reference in its entirety.

### FIELD OF THE INVENTION

The present invention relates to the art of handicapped accessibility devices.

### STATEMENT REGARDING FEDERALLY-SPONSORED RESEARCH AND DEVELOPMENT

Not applicable.

### BACKGROUND OF THE INVENTION

Handicapped individuals dependent on mobility by way of wheelchairs, or other similar wheeled mobility type chairs, are restricted to such devices while carrying out day-to-day duties and societal interactions. Such restriction poses particular problems when a wheelchair bound person's interactions with others require the handicapped person to change orientation, such as height or angle of the handicapped person's body or extremities.

Wheelchair bound individuals periodically visit medical and dental facilities, where height and body adjustment are imperative for proper examination and treatment.

Wheelchair bound individuals also periodically visit hair salons, beauty parlors, movie theaters, sporting events, stadiums, and/or concerts, where the height of the seated individual must be adjusted to accommodate the height of the standing barber, hair stylist or beautician, or to provide a better viewing experience.

For the aforementioned reasons, there is a need to create a device to lift and tilt a wheelchair bound individual without requirement for moving or removing the individual from the wheelchair.

### BRIEF DESCRIPTION OF THE SEVERAL VIEWS OF THE DRAWINGS

The foregoing summary, as well as the following detailed description of the invention, will be better understood when read in conjunction with the appended drawings. For illustrating the invention, the figures are shown in the embodiments that are presently preferred. It should be understood, however, that the invention is not limited to the precise arrangements and instrumentalities shown. In the drawings:

FIG. 1 depicts at least one embodiment of the invention, namely a front-angular view of the wheelchair lifter in an elevated position.

FIG. 2 depicts at least one embodiment of the invention, namely a side view of the wheelchair lifter in an elevated position with an accompanying wheelchair.

FIG. 3 depicts at least one embodiment of the invention, namely a front-angular view of the wheelchair lifter in the floor level position.

FIG. 4 depicts at least one embodiment of the invention, namely a side, cross-sectional view of the wheelchair lifter in an elevated position.

FIG. 5 depicts at least one embodiment of the invention, namely a detailed view of the tilting mechanism of the wheelchair lifter.

FIG. 6 depicts at least one embodiment of the invention, namely a side, cross-sectional view of the wheelchair lifter with detailed diagram of the tilting mechanism.

FIG. 7 depicts at least one embodiment of the invention, namely a side, cross-sectional view of the wheelchair lifter with detailed diagram of the tilting mechanism in the tilted position.

FIG. 8 depicts at least one embodiment of the invention, namely a front-angular view of the wheelchair lifter with rounded corners and features.

FIG. 9 depicts at least one embodiment of the invention, namely a front-angular view of the wheelchair lifter with an accompanying wheelchair.

### DESCRIPTION OF THE INVENTION

The present invention depicts an inventive solution to the fore mentioned issues related to wheelchair bound individuals being lifted and tilted while seated in their wheelchair.

Unless otherwise defined, all terms of art, notations and other scientific terms or terminology used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art. Many of the techniques and procedures described, or referenced herein, are well understood and commonly employed using conventional methodology by those skilled in the art.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as only one of or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

In at least one embodiment, the present invention pertains to an apparatus for lifting and tilting a wheel chair bound person comprising a horizontal support; at least one lifting support, wherein the at least one lifting support is connected to the horizontal support; and at least one rear wheel stop, wherein the at least one rear wheel stop is positioned relative to the horizontal support, whereby a wheel chair is immobilized.

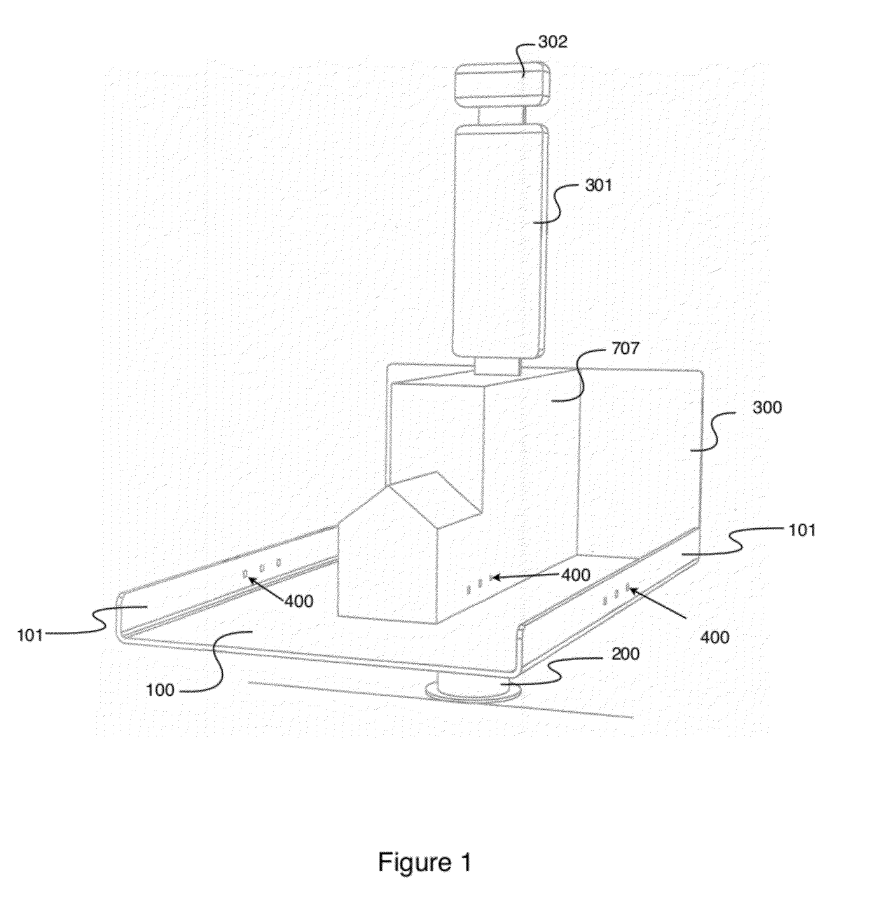

Referring now to the drawings in detail, a wheelchair lifting and tilting device is shown in FIG. 1. In at least one embodiment of the present invention, the invention pertains to an apparatus for lifting and tilting wheelchairs comprising a horizontal support 100; at least one lifting support 200, wherein the at least one lifting support 200 is connected to the horizontal support 100; and at least one rear wheel stop 300, wherein the at least one rear wheel stop 300 is positioned relative to the horizontal support 100, whereby a wheel chair is immobilized. In some embodiments, the at least one rear wheel stop is positioned or attached at one end of the horizontal support 100. In some embodiments, the at least one rear wheel stop 300 may be hingeably attached to the end of the horizontal support 100. In some embodiments, the at least one rear wheel stop 300 is adjustable. In some embodiments, the at least one rear wheel stop 300 is removable.

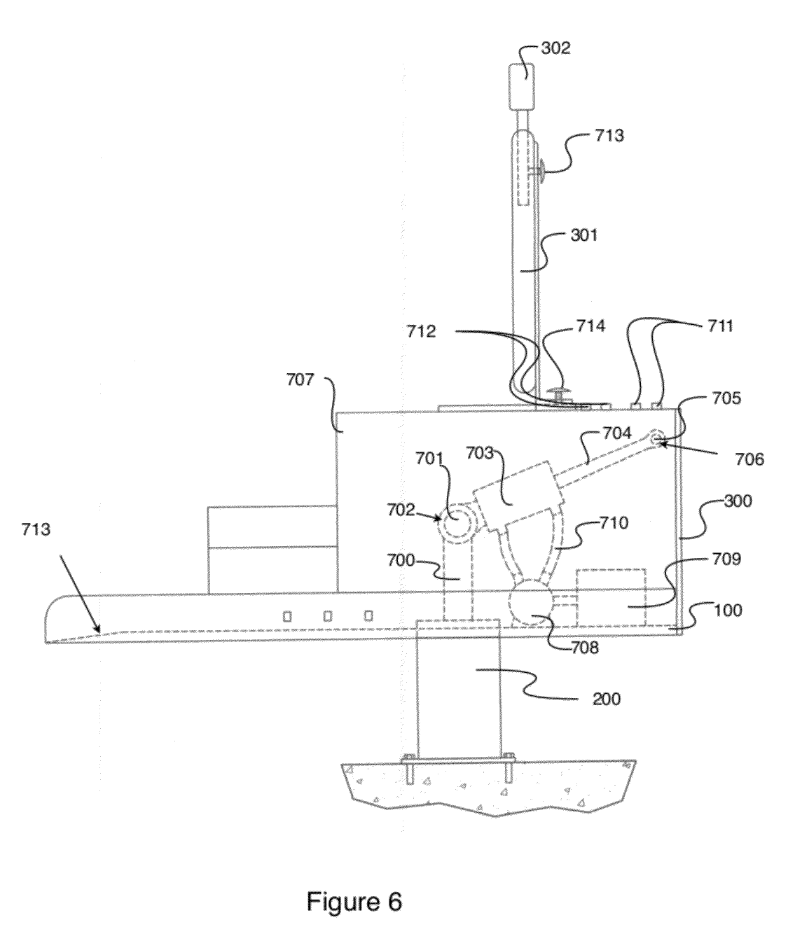

In some embodiments of the invention, the device further comprises wheel guard rails 101 along the horizontal support 100. The device may further comprise at least one wheel stop pin orifice 400. In another embodiment, at least one wheel stop retaining pin 500 may be insertable into the at least one wheel stop pin orifice 400. The at least one wheel stop retaining pin 500 serves as an interconnection of the at least one front wheel stop 600 between the wheel guard rails 101 and the housing 707. In some embodiments, the device further comprises a backrest 301. The backrest may be vertically and/or horizontally adjustable. In some embodiments, the backrest may have adjustment knobs or pins 714 for adjustment of the backrest horizontally or vertically. In other embodiments, the device may also comprise a headrest 302. The headrest may be vertically and/or horizontally adjustable. As shown in FIG. 6, in some embodiments, the headrest may have adjustment knobs or pins 713 for adjustment of the headrest horizontally or vertically. In some embodiments, the device also contains a housing 707 surrounding the interconnection of the at least one lifting support and the horizontal support 100. The housing can serve aesthetic purposes and/or as a cover over the lifting support 200 and other mechanical structures used in the device to be described herein.

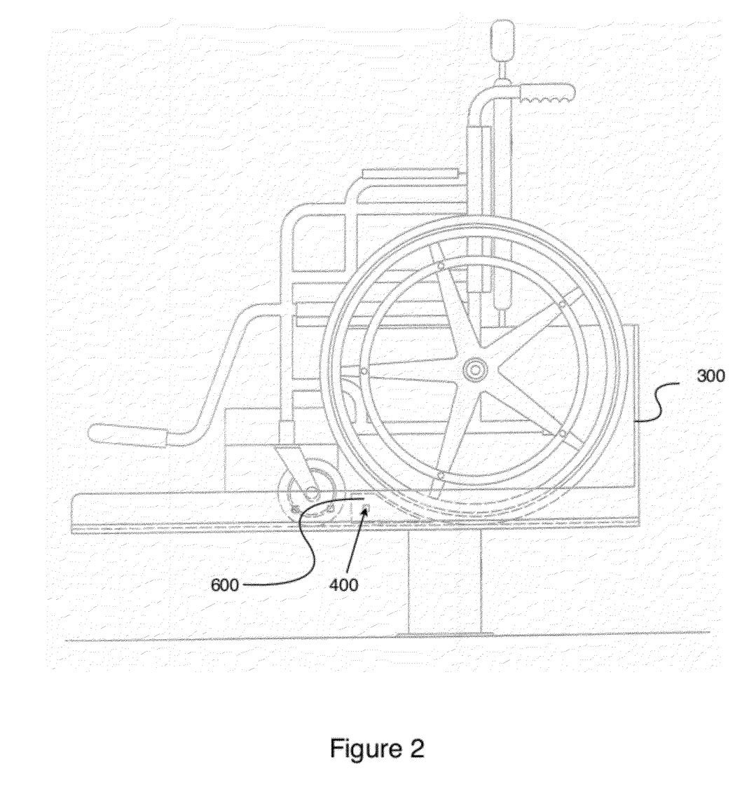

As shown in FIG. 2, a wheel chair may be securely positioned on the wheel chair lifting and tilting device by positioning the wheel chair where the at least one front wheel stop 600 and at least one rear wheel stop 300 immobilize the wheel chair. The front wheel stop 600 may be secured and positioned for immobilizing a wheel by using at least one wheel stop retaining pin inserted into at least one wheel stop pin orifice 400. The front wheel stop 600 may also be positioned and secured by other means, such as by electromechanical mechanisms.

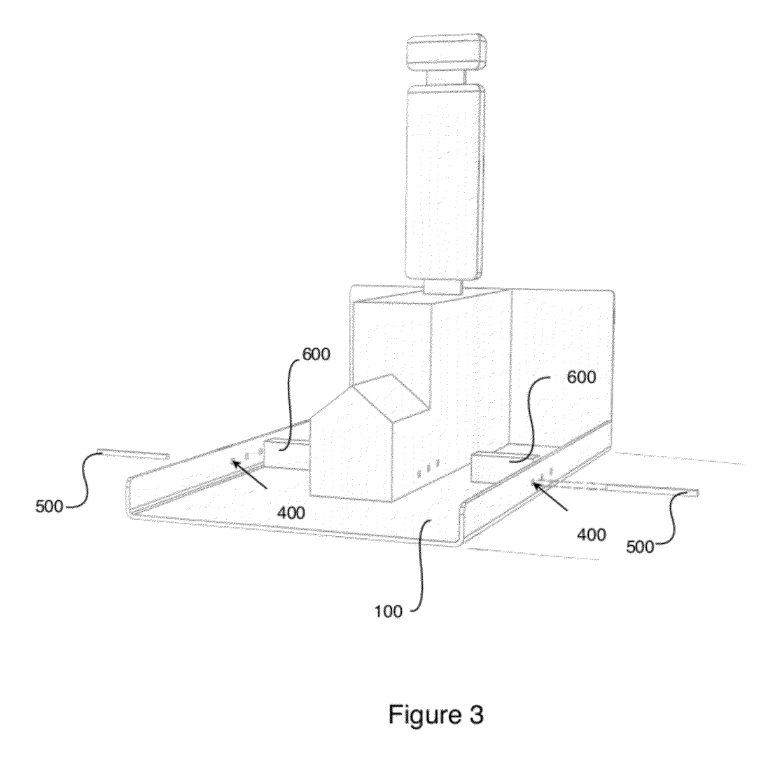

In another embodiment, as depicted in FIG. 3, the device comprises at least one front wheel stop 600, wherein the at least one front wheel stop 600 is positioned against, or relative to, the horizontal support 100. In some embodiments, the at least one front wheel stop 600 may be removable and/or adjustable. In some embodiments, the at least one front wheel stop 600 may be automatically removable and/or adjustable. In some embodiments, the at least one front wheel stop 600 may be manually removable and/or adjustable. The at least one front wheel stop 600 may be positioned by use of at least one wheel stop retaining pin 500 inserted into at least one wheel stop pin orifice 400. In another embodiment, the wheel stop retaining pin and front wheel stop are combined as one unit. The one unit may also be slideably attached to the device to allow for adjustment of the unit to ensure proper retention of the wheel. The unit may also be movable such that it can be adjusted by interaction with the at least one wheel stop pin orifice 400. The unit could also be adjusted and secured by electromechanical means, such as, but not limited to, electromagnetic locks.

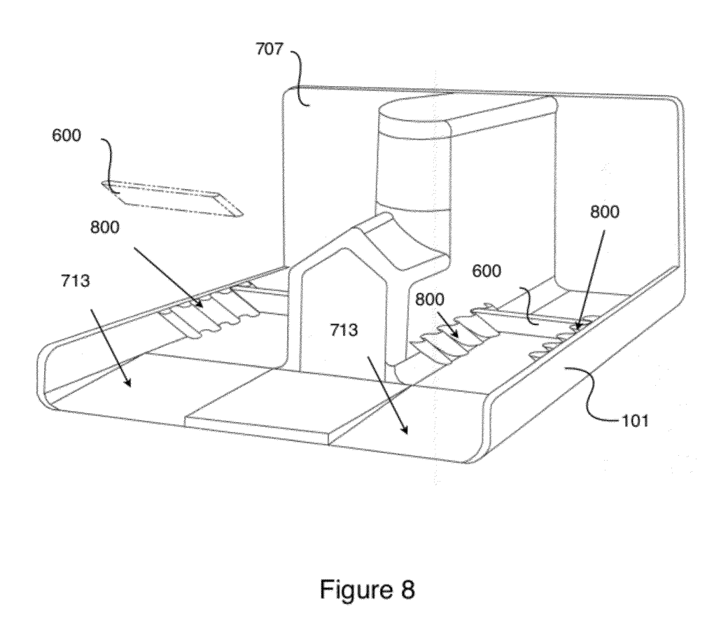

In some embodiments, the at least one front wheel stop 600 may be positioned and secured by male and female bone joints 800, as depicted in FIG. 8. The bone joints may be built/designed vertically into the wheel guard rails 101 and/or housing 707. In some embodiments, the male and female bone joints 800 are slideably attached or mounted.

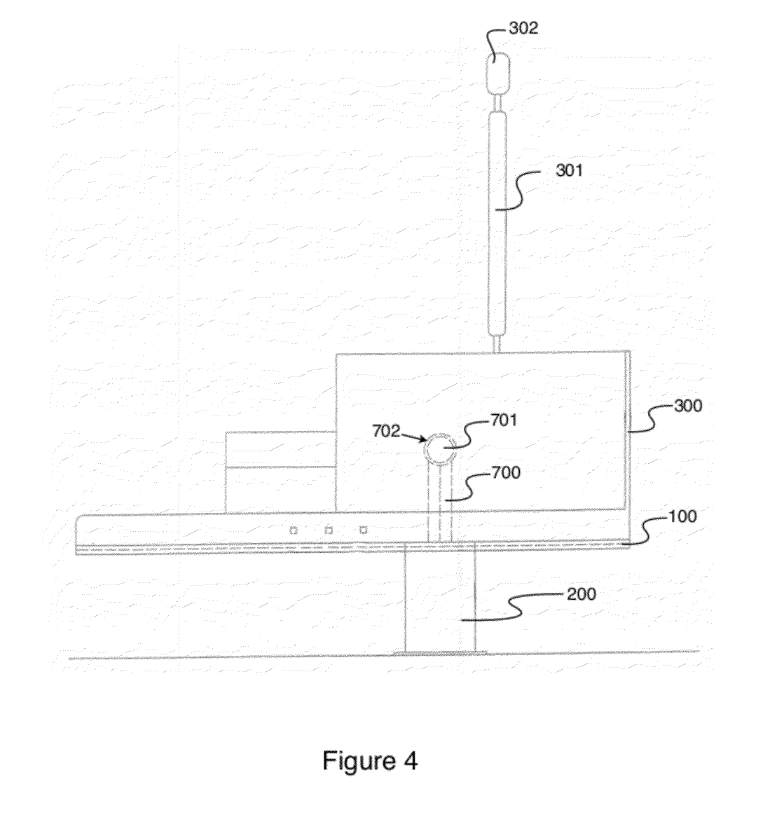

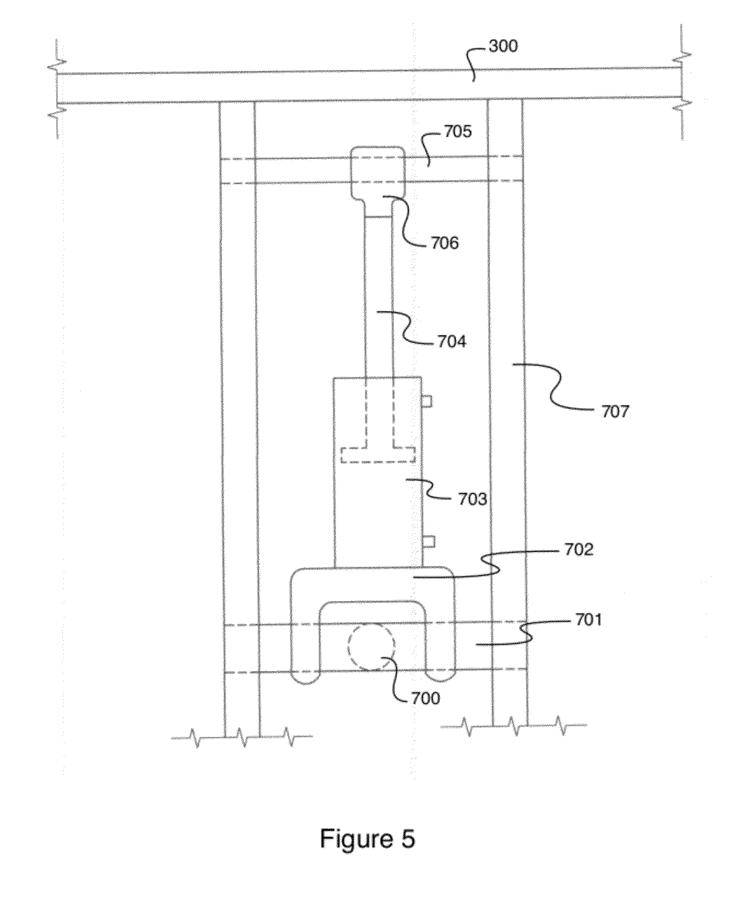

In another embodiment, as depicted in FIG. 4 and FIG. 5, a wheelchair lifting/tilting device is shown comprising a horizontal support 100; at least one lifting support 200, wherein the at least one lifting support 200 is pivotably connected to the horizontal support 100; and at least one rear wheel stop 300, wherein the at least one rear wheel stop 300 is positioned relative to the horizontal support 100, whereby a wheel chair is immobilized. The device is capable of pivoting by way of a tilting mechanism. The tilting mechanism is made up of a hydraulic cylinder 703 and piston rod 704 interconnected between a tilting shaft 705 and a lifting shaft 701. The hydraulic cylinder may also be a double action hydraulic cylinder. The piston rod 704 attaches to the tilting shaft 705 via a piston rod clevis 706. The hydraulic cylinder 703 attaches to the lifting shaft 701 via a hydraulic cylinder clevis 702. It would be understood by those skilled in the art that the orientation of the tilting mechanism may be reversed.

In some embodiments, a rack and pinion system is implemented as the tilting mechanism.

As shown in FIG. 4, the lifting piston rod 700 may extend upward from the at least one lifting support 200. The end of the lifting piston rod 700 may interconnect with the lifting shaft 701 via a hydraulic cylinder clevis 702.

In another embodiment, as depicted in FIG. 6, the wheelchair lifting/tilting device is shown with the tilting mechanism in place. In this embodiment, the tilting mechanism is in the untilted position. The wheelchair lifting/tilting device, as shown, comprises a horizontal support 100; at least one lifting support 200, wherein the at least one lifting support 200 is pivotably connected to the horizontal support 100; and at least one rear wheel stop 300, wherein the at least one rear wheel stop 300 is positioned relative to the horizontal support 100, whereby a wheel chair is immobilized. The device of this embodiment is capable of pivoting by way of a tilting mechanism. The tilting mechanism is made up of a hydraulic cylinder 703 and piston rod 704 interconnected between a tilting shaft 705 and a lifting shaft 701. The hydraulic cylinder may also be a double action hydraulic cylinder. The piston rod 704 attaches to the tilting shaft 705 via a piston rod clevis 706. The hydraulic cylinder 703 attaches to the lifting shaft 701 via a hydraulic cylinder clevis 702. It would be understood by those skilled in the art that the orientation of the tilting mechanism may be reversed. Hydraulic fluid hoses 710 may connect the hydraulic cylinder 703 to a hydraulic motor pump unit 708 and a hydraulic fluid reservoir 709. The lifting mechanism is interconnected with the lifting support 200 via the lifting piston rod 700. The lifting and tilting of the device may be activated by lifting device actuators 711 and tilting device actuators 712. These actuators may be electromagnetic. In some embodiments, the horizontal support may also contain a ramp 713 to aid in the loading and unloading of a wheelchair. The entire mechanical structures of the tilting and lifting mechanism may be covered by a housing 707.

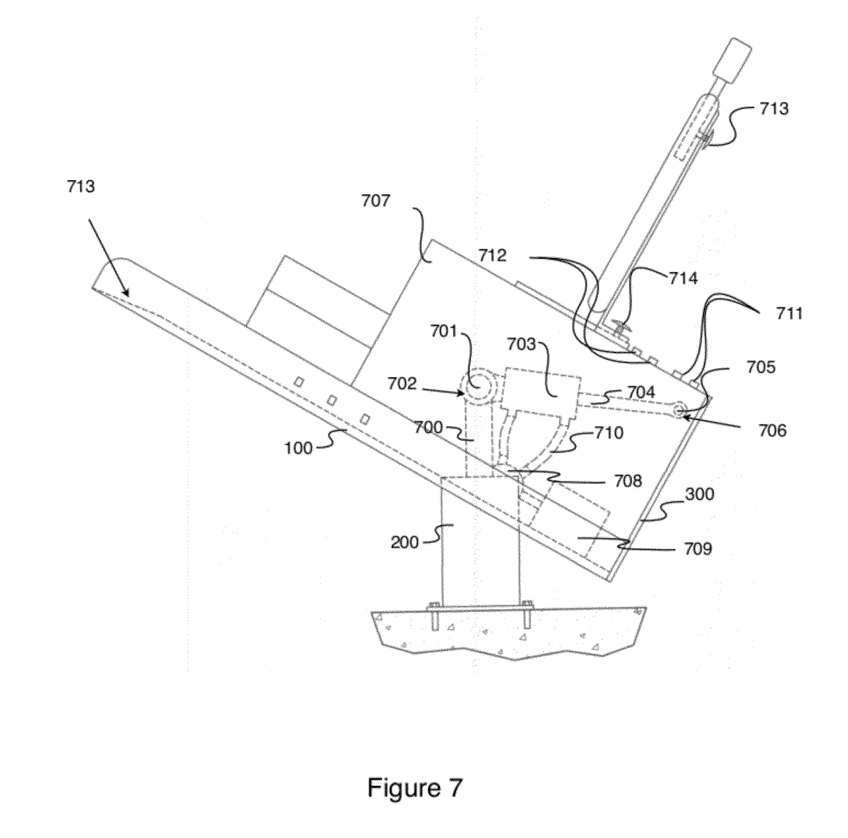

In another embodiment, as depicted in FIG. 7, the wheelchair lifting/tilting device is shown with the tilting mechanism in place. In this embodiment, the tilting mechanism is in the tilted position. The wheelchair lifting/tilting device, as shown, comprises a horizontal support 100; at least one lifting support 200, wherein the at least one lifting support 200 is pivotably connected to the horizontal support 100; and at least one rear wheel stop 300, wherein the at least one rear wheel stop 300 is positioned relative to the horizontal support 100, whereby a wheel chair is immobilized. The device of this embodiment is capable of pivoting by way of a tilting mechanism. The tilting mechanism is made up of a hydraulic cylinder 703 and piston rod 704 interconnected between a tilting shaft 705 and a lifting shaft 701. The hydraulic cylinder may also be a double action hydraulic cylinder. The piston rod 704 attaches to the tilting shaft 705 via a piston rod clevis 706. The hydraulic cylinder 703 attaches to the lifting shaft 701 via a hydraulic cylinder clevis 702. It would be understood by those skilled in the art that the orientation of the tilting mechanism may be reversed. Hydraulic fluid hoses 710 may connect the hydraulic cylinder 703 to a hydraulic motor pump unit 708 and a hydraulic fluid reservoir 709. The lifting mechanism is interconnected with the lifting support 200 via the lifting piston rod 700. The lifting and tilting of the device may be activated by lifting device actuators 711 and tilting device actuators 712. These actuators may be electromagnetic. In some embodiments, the horizontal support may also contain a ramp 713 to aid in the loading and unloading of a wheelchair. The entire mechanical structures of the tilting and lifting mechanism may be covered by a housing 707.

In another embodiment, as depicted in FIG. 8, the wheelchair lifting/tilting device may contain curved aesthetic features.

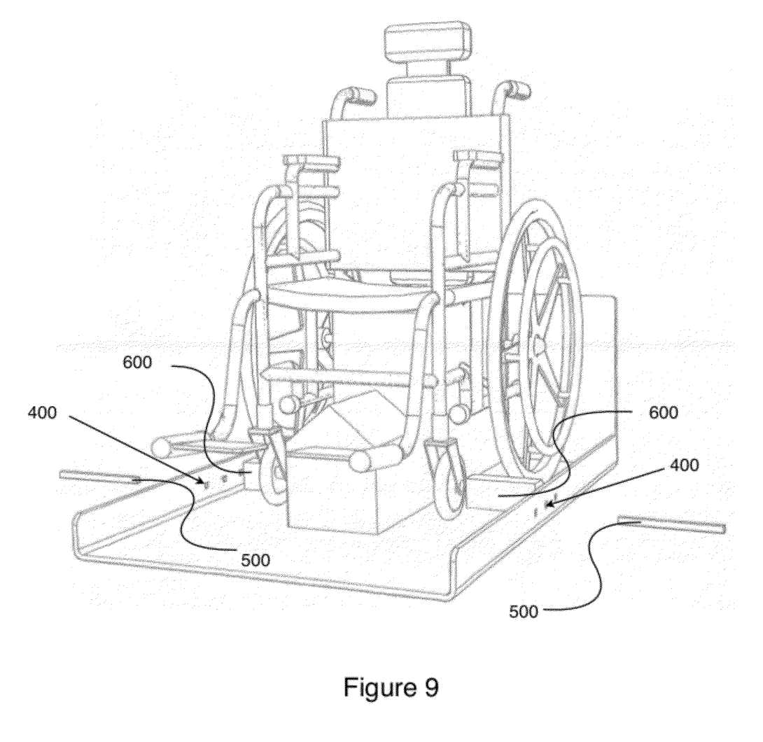

In another embodiment, as depicted in FIG. 9, the wheelchair lifting/tilting device is shown with a wheelchair in place. In some embodiments, as shown, the at least one front wheel stop 600 is positioned and at least one wheel stop retaining pin 500 inserted into at least one wheel stop pin orifice 400.

It is to be appreciated that the Detailed Description section, and not the Abstract section, is intended to be used to interpret the claims. The Abstract section may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance. The breadth and scope of the present invention should not be limited by any of the above-described exemplary embodiments, but should be defined only in accordance with the following claims and their equivalents.

What is claimed is:

1. A wheel chair lifter, comprising:
a horizontal support;
at least one lifting support, wherein the at least one lifting support is connected to the horizontal support; and
at least one rear wheel stop, wherein the at least one rear wheel stop is positioned relative to the horizontal support, whereby a wheel chair is immobilized.

2. The wheel chair lifter of claim 1, further comprising at least one front wheel stop, wherein the at least one front wheel stop is removable.

3. The wheel chair lifter of claim 1, further comprising at least one front wheel stop, wherein the at least one front wheel stop is adjustable.

4. The wheel chair lifter of claim 3, wherein the at least one front wheel stop is removable.

5. The wheel chair lifter of claim 1, wherein the at least one rear wheel stop is attached to an end of the horizontal support.

6. The wheel chair lifter of claim 1, further comprising wheel guard rails along opposing ends of the horizontal support.

7. The wheel chair lifter of claim 6, further comprising a housing surrounding the interconnection of the at least one lifting support and the horizontal support.

8. The wheel chair lifter of claim 1, wherein the at least one rear wheel stop is hingeably attached to the end of the horizontal support.

9. The wheel chair lifter of claim 1, wherein the at least one rear wheel stop is adjustable.

10. The wheel chair lifter of claim 1, wherein the at least one rear wheel stop is removable.

11. The wheel chair lifter of claim 3, wherein the at least one front wheel stop is automatically adjustable.

12. The wheel chair lifter of claim 3, wherein the at least one front wheel stop is manually adjustable.

13. The wheel chair lifter of claim 2, wherein the at least one front wheel stop is manually removable.

14. The wheel chair lifter of claim 1, further comprising a headrest.

15. The wheel chair lifter of claim 1, further comprising a backrest.

16. The wheel chair lifter of claim 7, wherein the wheel guard rails comprise one or more orifices for interconnection of the at least one front wheel stop between the wheel guard rails and the housing.

17. A wheel chair lifting/tilting apparatus, comprising:
a horizontal support;
at least one lifting support, wherein the at least one lifting support is pivotably connected to the horizontal support; and
at least one rear wheel stop, wherein the at least one rear wheel stop is positioned relative to the horizontal support, whereby a wheel chair is immobilized.

18. The wheel chair lifter of claim 17, further comprising at least one front wheel stop.

19. The wheel chair lifter of claim 17, further comprising a housing surrounding the interconnection of the at least one lifting support and the horizontal support.

20. The wheel chair lifter of claim 18, wherein the at least one front wheel stop is removable and/or adjustable.
